(19) United States
(12) Patent Application Publication
(10) Pub. No.: US 2024/0400055 A1
(43) Pub. Date: Dec. 5, 2024

(54) VEHICLE PASSING OPERATION

(71) Applicant: Ford Global Technologies, LLC, Dearborn, MI (US)

(72) Inventors: Andrew Denis Lewandowski, Sterling Heights, MI (US); Keith Weston, Canton, MI (US); Brendan Francis Diamond, Grosse Pointe, MI (US); Jordan Barrett, Milford, MI (US)

(73) Assignee: Ford Global Technologies, LLC, Dearborn, MI (US)

(21) Appl. No.: 18/326,165

(22) Filed: May 31, 2023

(51) Int. Cl. B60W 30/18; B60W 40/068; B60W 50/00; B60W 50/14; G08G 1/16

(52) U.S. Cl. CPC B60W 30/18163; B60W 40/068; B60W 50/0097; B60W 50/14; G08G 1/162; B60W 40/13; B60W 2520/10; B60W 2520/105; B60W 2556/65

(57) ABSTRACT

A system can include a computer having a processor and memory, the memory storing instructions executable by the processor to determine, at a first vehicle, a first time interval that is available to pass a second vehicle operating in a path of the first vehicle. The instructions may additionally be to compute, based on a predicted motion model that includes a first estimate of road friction of the first vehicle operating along the path, a second time interval for the first vehicle to pass the second vehicle in which, upon determining that the second time interval is less than or equal to the first time interval, actuate a component of the first vehicle.

### BACKGROUND

In various driving environments a vehicle operator may wish to pass or overtake a second vehicle, located in front of the operator's vehicle, which may be traveling at a slow pace.

### BRIEF DESCRIPTION OF THE DRAWINGS

FIG. 1 is a diagram illustrating an example vehicle traveling on a two-lane road.

FIG. 2 is a diagram of a first vehicle passing a second vehicle operating on a two-lane road.

FIG. 3 is a flowchart of an exemplary process for actuating a component for a vehicle passing operation.

### DETAILED DESCRIPTION

Disclosed herein are systems and methods for a first vehicle to overtake or pass a second vehicle located in a forward direction in relation to the first vehicle. While operating on a roadway with adjacent lanes provides for travel in opposite directions, the first vehicle may utilize various sensors, e.g., sensors of a global positioning system or GPS, to locate the first vehicle on a digital map. Responsive to locating the first vehicle on the digital map, an operator may determine that the roadway appears to be without significant curves and/or other impediments, so as to be favorable for engaging in an operation to pass a second vehicle located in front of the first vehicle, e.g., moving at a speed below a posted speed limit. A computer of the first vehicle may then communicate with the second vehicle to permit the first vehicle to utilize sensor data obtained by the second vehicle. Sensor data received from the second vehicle may permit the first vehicle to determine whether a moving object, such as a third vehicle traveling in the direction opposite to the direction of travel of the first vehicle or a static object, such as a downed tree, is present in a lane designated for travel in an opposite direction. Based on detection of a moving or a static object traveling in or present in a lane designated for travel in an opposite direction, the first vehicle may determine a time interval before the object comes within the vicinity of the first vehicle. In this disclosure, an operator means an entity providing input to control the vehicle. Thus, an operator can include a human operator or a vehicle computer unless explicitly stated otherwise or clearly one or the other from context.

A computer of the first vehicle may implement a predicted motion model, which utilizes vehicle weight and propulsion input parameters, to compute a prediction of how rapidly the first vehicle can apply suitable propulsion inputs to permit the vehicle to increase its velocity, pass the second vehicle, and return to the designated lane. The predicted motion model can additionally utilize an estimate of road friction, which may determine whether the first vehicle can suitably increase and maintain its velocity to perform the passing operation. In this context, “road friction” has the conventional meaning of an empirical property of adjacent materials as the two materials come into static or sliding contact with one another. A coefficient of friction, i.e., a ratio of friction force to a normal force on a surface, can be used to describe friction such as road friction. In examples road friction may relate to a tendency for a tire of a vehicle to remain in contact with the surface of a roadway without the vehicle tire breaking traction with the road surface. During a passing operation, programming of the computer of the first vehicle may utilize sensors of the first vehicle to update estimates of road friction, which may result in the computer actuating an indicator, for example, to inform the operator whether the passing operation should be continued or whether the operator should return the first vehicle to an initial location relative to the second vehicle, such as to a location to the rear of the second vehicle.

In an example, a system includes computer having a processor and memory, the memory storing instructions executable by the processor to determine, at a first vehicle, a first time interval that is available to pass a second vehicle operating in a path of the first vehicle and to compute, based on a predicted motion model that includes a first estimate of road friction of the first vehicle operating along the path, a second time interval for the first vehicle to pass the second vehicle. The instructions can additionally be to, upon determining that the second time interval is less than or equal to the first time interval, actuate a component of the first vehicle.

The actuated component can be a component of a human-machine interface.

The actuated component can be a propulsion component.

The predicted motion model can include an acceleration capability of the first vehicle that is reduced by the first estimate of road friction of the first vehicle.

The instructions to update the second time interval can include instructions to compute a second estimate of the road friction, and can include instructions to decrease a propulsion input to the predicted motion model responsive to the second estimate of the road friction.

The instructions can further include instructions to compute a second estimate of the road friction, to input the second estimate to the predicted motion model, and to compute, via the predicted motion model, an update to the second time interval utilizing the second estimate of the road friction. The instructions can be further to actuate a component of a human-machine interface to return the first vehicle to the path responsive to the updated second time interval being greater than a remaining portion of the first time interval.

The instructions can further include instructions to compute a second estimate of the road friction, to input the second estimate to the predicted motion model, and to compute, via the predicted motion model, an update to the second time interval utilizing the second estimate of the road friction. The instructions can further be to actuate a propulsion component of the first vehicle to the path responsive to the updated second time interval being less than a remaining portion of the first time interval.

The instructions to compute the second time interval include instructions to input, to the predicted motion model, an upper limit to velocity or acceleration of the first vehicle responsive to receipt of an input to a human-machine interface component of the first vehicle.

The predicted motion model can include an estimate of a weight of the first vehicle and an acceleration capability of the first vehicle.

The instructions can further include instructions to detect a third vehicle having a direction of travel substantially opposite to a direction of travel of the first vehicle. In which the second time interval is based on the direction of travel of the second vehicle, and in which the instructions to detect the third vehicle include instructions to communicate with the second vehicle via a V2V communications link.

The instructions can further be to obtain an indication of a location of the first vehicle on a road prior to executing the instructions to determine the second time interval.

In an example, a method can include determining, at a first vehicle, a first time interval to pass a second vehicle operating in a path of the first vehicle. The method can additionally include computing based on a predicted motion model that includes a first estimate of road friction of the first vehicle operating along the path, a second time interval for the first vehicle to pass the second vehicle. The method can further include, upon determining that the second time interval is less than or equal to the first time interval, actuating a component of the first vehicle.

The actuated component can be a component of a human-machine interface.

The actuated component can be a propulsion component.

The predicted motion model can include an acceleration capability of the first vehicle that is reduced by the first estimate of road friction of the first vehicle.

The method can further include computing a second estimate of the road friction and decreasing a propulsion input to the predicted motion model responsive to the computed second estimate of the road friction.

The method can additionally include computing a second estimate of the road friction, inputting the second estimate to the predicted motion model, and computing, via the predicted motion model, an update to the second time interval utilizing the second estimate of the road friction. The method can additionally include actuating a component of a human-machine interface to return the first vehicle to the path responsive to the updated second time interval being greater than a remaining portion of the first time interval.

The method can additionally include computing a second estimate of the road friction, inputting the second estimate to the predicted motion model, and computing, via the predicted motion model, an update to the second time interval utilizing the second estimate of the road friction. The method can additionally include actuating a propulsion component of the first vehicle to the path responsive to the updated second time interval being less than a remaining portion of the first time interval.

The method can additionally include receiving an upper limit to velocity or acceleration of the first vehicle responsive to receipt of an input signal from a human-machine interface component of the vehicle and inputting, to the predicted motion model, an upper limit to velocity or acceleration of the first vehicle.

The method can additionally include obtaining electronic horizon data indicating a position of the first vehicle on a road depicted on a digital map prior to computing the second time interval.

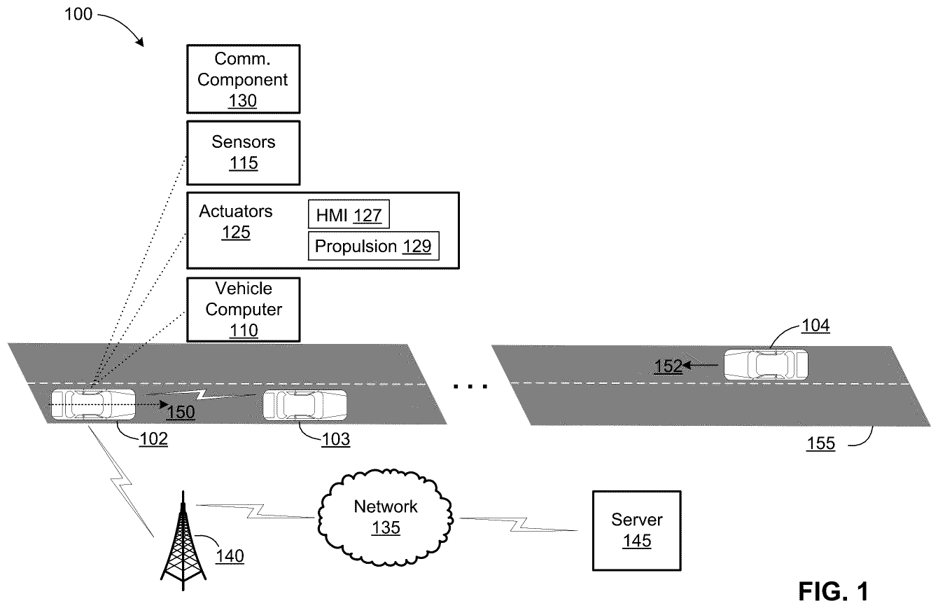

FIG. 1 shows diagram 100 illustrating an example vehicle traveling on a two-lane road. Diagram 100 includes a vehicle 102, which is a land vehicle such as a car, truck, etc. Vehicle 102 includes vehicle computer 110, vehicle sensors 115, actuators 125 to actuate various vehicle components, such as components of a human-machine interface (HMI) 127, propulsion components, steering and braking components, etc. Vehicle 102 can additionally include vehicle communications component 130. Communications component 130 can permit computer 110 of vehicle 102 to communicate with one or more of transceiver 140, central server 145, and/or one or more second vehicles, such as second vehicle 103, which may be equipped similar to vehicle 102. Vehicle computer 110 includes a processor and a memory. The memory can include one or more forms of computer-readable media, and stores instructions executable by vehicle computer 110 for performing various operations, including those disclosed herein.

Vehicle computer 110 may operate vehicle 102 in an autonomous, a semi-autonomous mode, or a non-autonomous (manual) mode. For purposes of this disclosure, an autonomous mode is defined as one in which each of vehicle 102 propulsion, braking, and steering are controlled by the vehicle computer 110; in a semi-autonomous mode, vehicle computer 110 controls one or two of propulsion, braking, and steering of vehicle 102; in a non-autonomous mode a human operator controls each of vehicle 102 propulsion, braking, and steering.

Vehicle computer 110 may include programming to operate one or more of vehicle 102 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when vehicle computer 110, as opposed to a human operator, is to control such operations. Additionally, vehicle computer 110 may be programmed to determine whether and when a human operator is to control such operations.

Vehicle computer 110 may include or be communicatively coupled to, e.g., communications component 130 as described further below, more than one processor, e.g., included in electronic controller units (ECUs) or the like included in vehicle 102 for monitoring, actuating, and/or controlling various vehicle actuators 125, e.g., a powertrain actuators, a brake actuators, a steering actuator, etc. Further, vehicle computer 110 may communicate, via communications component 130, with a navigation system that uses signals from a satellite positioning system, e.g., GPS. As an example, vehicle computer 110 may request and receive location data of vehicle 102. The location data may be in a known form, e.g., geo-coordinates in a global-reference frame (i.e., latitudinal and longitudinal coordinates).

Vehicle computer 110 can be generally arranged for communications with communications component 130 and with an internal wired and/or wireless network, e.g., a bus or the like of vehicle 102, such as a controller area network (CAN) or the like, and/or other wired and/or wireless mechanisms. Utilizing a communications network of vehicle 102, vehicle computer 110 can transmit messages to various devices in vehicle 102 and/or receive messages from the various devices, e.g., vehicle sensors 115, actuators 125, which may include human-machine interface (HMI 127), propulsion and/or powertrain components (e.g., propulsion 129), etc. Alternatively or additionally, in examples in which the vehicle computer 110 actually comprises a plurality of devices, a communications network of vehicle 102 may be used for communications between devices represented as vehicle computer 110 in this disclosure. Further, as mentioned below, various controllers and/or vehicle sensors 115 may provide data to vehicle computer 110.

Vehicle sensors 115 may include a variety of devices such as are known to provide data to vehicle computer 110. For example, vehicle sensors 115 may include Light Detection and Ranging (LIDAR), sensor(s) 115, etc., disposed on a top of vehicle 102, behind vehicle 102 front windshield, around vehicle 102, etc., that provide relative locations, sizes, and shapes of objects and/or conditions surrounding vehicle 102, including objects on and/or conditions of roadway 155. As another example, one or more radar sensors 115 fixed to bumpers of vehicle 102 can provide data to provide range and velocity of objects (possibly including second vehicles, e.g., vehicles 103 and 104), etc., relative to the location of vehicle 102. Vehicle sensors 115 may further alternatively or additionally, for example, include camera sensor(s) 115, e.g., front view, side view, etc., to provide images from a field of view inside and/or outside the vehicle 102.

Actuators 125 are implemented via circuits, chips, indicators (e.g., lamps, audible indicators, haptic indicators) motors (e.g., stepper motors), or other electronic and/or mechanical components that can actuate various vehicle subsystems in accordance with appropriate control signals. Actuators 125 may be used to control various components, including braking, acceleration, and steering of vehicle 102.

In the context of the present disclosure, a vehicle component is one or more hardware components adapted to perform a mechanical, electric, or electro-mechanical function or operation-such as moving the vehicle 102, slowing or stopping the vehicle 102, steering the vehicle, providing a stimulus to an indicator for viewing by the operator of vehicle 102, etc. Non-limiting examples of actuators 125 include an actuator of a propulsion input component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a component of a human-machine interface, etc.

In addition, computer 110 can be configured to communicate via a vehicle-to-vehicle communication component 130 with devices outside of vehicle 102, e.g., through a vehicle-to-vehicle (V2V) or vehicle-to-infrastructure (V2X) wireless communications to another vehicle, to transceiver 140 (e.g., via direct radio frequency communications) and/or (e.g., via network 135) server 145. Communications component 130 could include one or more mechanisms by which vehicle computer 110 may communicate, including any desired combination of wireless (e.g., cellular, wireless, satellite, microwave, and radio frequency) communication mechanisms and any desired network topology (or topologies when a plurality of communication mechanisms are utilized). Exemplary communications provided via communications component 130 include cellular, Bluetooth®, IEEE 802.11, dedicated short range communications (DSRC), and/or wide area networks (WAN), including the Internet, providing data communication services.

Network 135 includes one or more mechanisms by which a vehicle computer 110 may communicate with transceiver 140, server 145, and/or second vehicle 103. Accordingly, network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

Server 145 can be a conventional computing device, i.e., including one or more processors and one or more memories, programmed to provide operations such as disclosed herein. Further, server 145 can be accessed via the network 135, e.g., the Internet or some other wide area network.

In an example, an operator of vehicle 102 may proceed along path 150 on roadway 155. At times, progress of vehicle 102 may be impeded by the presence of a second vehicle, such as second vehicle 103. Thus, the operator of vehicle 102 may wish to overtake or pass second vehicle 103, so as to permit vehicle 102 to proceed along path 150 on roadway 155 at a higher speed (subject to a posted speed limit and/or safety factors). Prior to initiating an operation to pass or overtake second vehicle 103, the operator of vehicle 102 may observe a display rendering electronic horizon data in the form of a digital map that shows roadway 155 as including a geography that is favorable (e.g., a relatively straight and/or unobstructed section of roadway 155) to passing second vehicle 103. Electronic horizon data is a collection of data, as will be understood, obtained via vehicle sensors and/or stored map data indicating a current position or location of the vehicle and predicting a future trajectory of the vehicle with respect to an upcoming portion of a roadway, e.g., including road geometry (e.g., curvature), topology, and attributes (e.g., lanes, speed limits, etc.). In this context, to “pass” or “overtake” vehicle 102 means to briefly move from a first traffic lane to a second traffic lane (typically the second traffic lane is designated for use by oncoming traffic), increase the velocity of vehicle 102, and exit the oncoming traffic lane after advancing a suitable distance in a forward direction with respect to second vehicle 103.

Computer 110 of first vehicle 102 may communicate with second vehicle 103 so as to obtain sensor data from second vehicle 103, which may provide an unobstructed view of third vehicles or other objects, moving or stationary, in the oncoming traffic lane (e.g., vehicle 104 traveling along path 152). Computer 110 of vehicle 102 may compute a first time interval, which includes the time interval before an oncoming vehicle or other object could be encountered by vehicle 102. Computer 110 of vehicle 102 may compute a second time interval, which includes the time interval that would be consumed if vehicle 102 were to pass second vehicle 103. In computing the second time interval, computer 110 can implement a predicted motion model, which typically utilizes the weight of vehicle 102 (e.g., passengers, baggage, etc.), and any nonmotorized vehicles (e.g., a trailer) being pulled or towed by vehicle 102, and the propulsion capabilities of vehicle 102 (e.g., engine torque output). Computation of a second time interval can include an estimate of the road friction of vehicle 102 operating on roadway 155 to determine if road friction is greater than a first threshold value (e.g., a coefficient of road friction of 0.65, 0.7, 0.75, etc.).

In a manual mode of operation of vehicle 102, in response to the computed second time interval being less than the computed first time interval, computer 110 can actuate an indicator to inform the operator of vehicle 102 that favorable conditions exist to pass second vehicle 103. In an autonomous or semi-autonomous mode of operation of vehicle 102, in response to the computed second time interval being less than the computed first time interval, the operator of vehicle 103 (i.e., computer 110) can actuate propulsion and/or steering of vehicle 102 so as to autonomously or semi-autonomously initiate an operation to pass or overtake second vehicle 103. During a passing operation, vehicle computer 110 can monitor conditions of roadway 155, e.g., utilizing cameras of vehicle 102, to determine whether an estimate of road friction remains above the threshold value. In response to an estimate of road friction remaining above the threshold value, vehicle 102 may continue the passing operation. In response to an estimate of road friction dropping below the first threshold value, e.g., a coefficient of road friction of 0.5, 0.55, 0.6, etc., vehicle 102 may terminate the passing operation and return to the previous lane, e.g., to the rear of second vehicle 103.

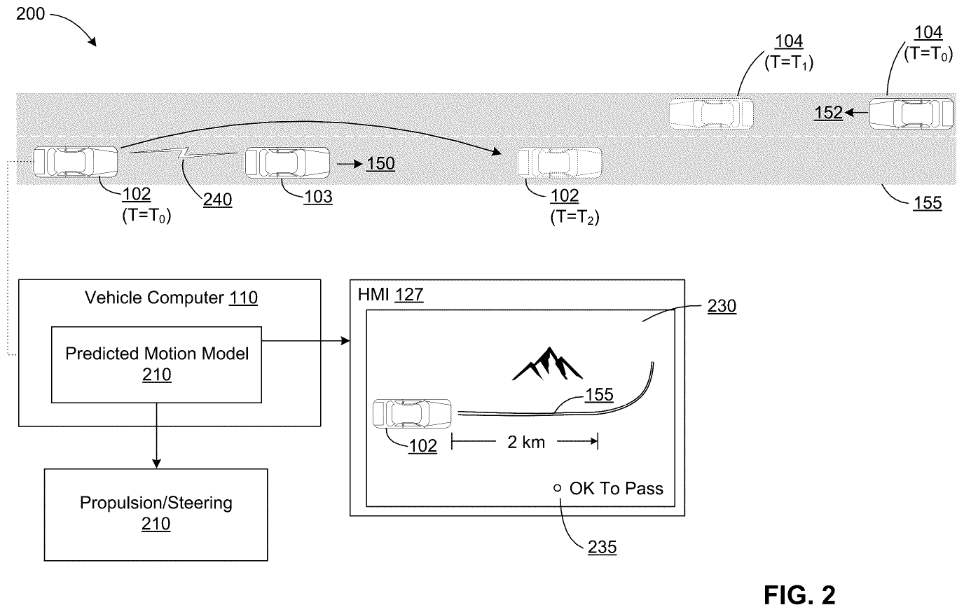

FIG. 2 is a diagram 200 of a first vehicle passing a second vehicle operating on a two-lane road. As seen in FIG. 2, vehicle 102 approaches second vehicle 103 while both are traveling along path 150 on roadway 155. Prior to initiating an operation to pass or overtake vehicle 103, an operator of vehicle 102 may observe digital map 230 displayed via human-machine interface 127. The operator of vehicle 102 may determine that, for example, a substantial distance of relatively straight and unobstructed roadway 155, depicted on digital map 230, proceeds for some distance, such as a distance of greater than 1 kilometer (km). For example, the distance could be empirically determined and stored in a memory accessible to computer 110, e.g., based on operating vehicles of various weights on various kinds of roadways and/or test tracks or test environments at different speeds and then recording or determining distances. In an example, distance could be dependent on a road being substantially free of curves (e.g., having a curvature below a threshold, such as 3°, 4°, 5°, etc.) for a specified distance based on a specified current speed and expected speed to overtake or pass another vehicle. The operator of vehicle 102 may thus determine that the depicted stretch of roadway 155 is permitted for passing or overtaking second vehicle 103. In the example of FIG. 2 digital map 230 indicates that an approximately 2-kilometer stretch of roadway 155, in a forward direction with respect to vehicles 102 and 103, appears substantially free of curves, inclining slopes (e.g., positive gradients or gradients above a threshold), intersections, bridges, grades, areas of merging traffic, road construction, and/or other features of roadway 155 that could impede the passing of second vehicle 103 by vehicle 102.

In an example, computer 110 of vehicle 102 may communicate with second vehicle 103 by way of V2V communications link 240. In such an example, vehicle 102 may request sensor data from second vehicle 103, which may provide a clearer view of areas of roadway 155 that may be obstructed from the view of vehicle 102. Thus, by way of V2V communications link 240, programming of computer 110 of vehicle 102 may determine that no static objects, e.g., stalled vehicles, structures, natural objects, debris, etc., or dynamic objects, e.g., other vehicles traveling along path 150 and/or path 152, are present within the range of a radar or other sensor of second vehicle 103 capable of detecting static or dynamic objects in a forward direction of second vehicle 103. In another example, sensor data from second vehicle 103 and/or sensor data from vehicle 102 may determine that an oncoming vehicle (i.e., vehicle 104) is present on roadway 155 but at a significant distance (e.g., 0.75 km, 1.0 km, etc.) from vehicles 102 and 103. Sensor data from second vehicle 103 and/or vehicle 102 can additionally determine the speed of the oncoming vehicle present on roadway 155.

Vehicle 102 can additionally compute an estimate of road friction between vehicle 102 and the surface of roadway 155. For example, sensors 115 of vehicle 102 may detect the presence or absence of precipitation along path 150 of roadway 155. An absence of precipitation on roadway 155 can be indicative of a coefficient of road friction that exceeds a first threshold value, e.g., 0.65, 0.7, 0.75, etc., which may indicate favorable conditions for overtaking or passing second vehicle 103. It should be noted that vehicle 102 may be capable of passing or overtaking second vehicle 103 responsive to estimation of a coefficient of road friction that is less than the first threshold value, e.g., 0.5, 0.55, 0.6, etc., such as may be encountered when precipitation is present on roadway 155, perhaps at lower velocities and/or values of acceleration of vehicle 102. In some instances, however, such as in response to detection of a presence of ice and/or snow on roadway 155, conditions may be unfavorable for vehicle 102 to pass second vehicle 103. Programming of computer 110 may estimate friction based on sensor data from previous cornering maneuvers (e.g., near-limit cornering) of vehicle 102, data from a traction control subsystem of vehicle 102, data from wheel sensors of vehicle 102, estimates of surface roughness of roadway 155, and so forth. Sensors 115 of vehicle 102 may additionally detect fog or other sources of obscuration in the immediate environment of the vehicle, which may indicate conditions unfavorable to passing or overtaking second vehicle 103.

In the example of FIG. 2, based on sensor measurements from second vehicle 103, as communicated by V2V communications link 240, as well as measurements from sensors 115 of vehicle 102, programming of computer 110 may implement predicted motion model 210. Predicted motion model 210 may operate to compute a first time interval (T₀→T₁) that is available to pass second vehicle 103 operating along path 150. The first time interval (T₀→T₁) could include a distance margin for vehicle 102 to return to the designated lane of roadway 155, e.g., at a distance of 15 meters, 20 meters, 25 meters, etc., in a forward direction from second vehicle 103. The distance margin could be dependent upon ambient light conditions, road friction, prevailing weather conditions, ambient lighting conditions, etc.

Predicted motion model 210 may utilize several measurements of the motion parameters of vehicle 104 (e.g., as determined by a radar sensor of sensors 115 of vehicle 102 and/or a radar sensor of second vehicle 103) for input into an optimal filter, e.g., an averaging filter, a Kalman filter, a particle filter, etc., so as to obtain an optimal estimation of the velocity of vehicle 104.

Predicted motion model 210 of vehicle 102 may implement a model of vehicle 102 to estimate parameters for operating the vehicle in a current environment and/or under current conditions. Parameters can include data describing physical attributes of the environment, such as a current road friction as well as vehicle parameters, such as current acceleration capability, current weight, etc. In this context, a predicted motion model means a computer model, implemented via programming of a computer 110, that predicts vehicle performance parameters, such as acceleration and velocity, based on vehicle propulsion parameters (e.g., output torque minus powertrain losses), aggregated vehicle weight parameters (e.g., vehicle weight, cargo weight, weight of any load being towed by vehicle 102, etc.), as a function of vehicle throttle positioning. In addition to vehicle performance parameters, a predicted motion model can include parameters relating to the vehicle's operational environment, such as a coefficient of road friction of roadway 155, drag coefficient for prevailing weather circumstances, gradient of roadway 155, etc. A predicted motion model can thus represent powertrain components and estimates of the current (e.g., real-time) state of each powertrain component to predict the performance and the predicted motion of vehicle 102. A predicted motion model can further include thermal limitations and horsepower/torque derating of powertrain components. Responsive to vehicle 102 including batteries and electric motors to propel the vehicle, a predicted motion model can include thermal limitations associated with above average current sourcing from the batteries of the vehicle as well as horsepower and torque derating of powertrain components. One such predicted motion model is Carsim mechanical simulation provided by the Mechanical Simulation Corporation at 755 Phoenix Dr, Ann Arbor, MI 48108 (www.carsim.com/products/carsim/), which provides detailed computerized methods for simulating the performance of passenger vehicles and light-duty trucks. Programming of computer 110 can thus implement predicted motion model 210 to predict a time interval to overtake or pass second vehicle 103 based on the real-time operating conditions of vehicle 102 and characteristics of roadway 155.

In an example, for vehicle 102 having an aggregated weight of 3000 kilograms, which includes vehicle weight and cargo of 2300 kilograms and the weight of a 700-kilogram vehicle being towed by first vehicle 102, having an acceleration capability of 1.8 m/sec², Table 1 summarizes example time periods to overtake or pass second vehicle 103:

TABLE 1

| Throttle | | | Distance to | Vehicle |
|---|---|---|---|---|
| position | Acceleration | Vehicle 103 | Overtake | Time-to- |
| (% of | Capability | Speed | Vehicle 103 | Pass |
| max) | (Meters/sec²) | (Kilometers/hour) | (Kilometers) | (Seconds) |
| 100 | 1.80 | 96 | .557 | 18.2 |
| 90 | 1.49 | 96 | .563 | 18.4 |
| 80 | 1.41 | 96 | .565 | 18.5 |
| 70 | 1.54 | 96 | .566 | 18.6 |
| 60 | 1.28 | 96 | .568 | 18.7 |

In the example of Table 1, vehicle 102 includes a length of 4.83 meters, which includes the length of a trailer under tow by vehicle 102, and wherein second vehicle 103 includes a cargo vehicle having a length of approximately 22 meters, and wherein vehicle 102 begins at a distance of approximately 54 meters to the rear of second vehicle 103 and completes overtaking or passing second vehicle 103 after achieving a distance of approximately 54 meters in a forward direction of the second vehicle.

In an example, predicted motion model 210 may utilize real-time or near-real-time signal inputs from sensors 115 to estimate the weight (e.g., vehicle weight and payload) and propulsion input parameters (e.g., engine output torque capability) of vehicle 102. Accordingly, predicted motion model 210 can predict, for example, an acceleration capability and/or a velocity capability of vehicle 102 as the vehicle engages in an operation to overtake or pass second vehicle 103. An acceleration capability and/or a velocity capability of vehicle 102 can be determined utilizing the vehicle weight to estimate a maximum force that can be applied between the vehicle's tires and the surface of roadway 155 to propel the vehicle along the roadway. Alternatively, or in addition, the predicted motion model can include longitudinal wheel slip determined from a wheel-slip sensor of sensors 115. Predicted motion model 210 may utilize an estimate of road friction to downwardly adjust (i.e., reduce) propulsion input parameters of vehicle 102 appropriate for the estimated road friction. In an example, responsive to an estimated coefficient of road friction greater than a first threshold value (e.g., 0.65, 0.7, 0.75) predicted motion model 210 may model motion of vehicle 102 utilizing an acceleration capability and/or a velocity capability of vehicle 102. In another example, responsive to an estimated coefficient of road friction that is less than the first threshold value (e.g., 0.5, 0.55, 0.6) predicted motion model 210 may represent motion of vehicle 102 utilizing an acceleration capability and/or a velocity capability of vehicle 102 that is reduced by a predetermined amount, e.g., 15%, 20%, 25%, etc. Predetermined amounts by which an acceleration capability is reduced can be determined for given configuration of vehicle 102 via empirical testing, for example, on a test track or on test roads having various surface characteristics and utilizing vehicles similar to vehicle 102 carrying a variety of weights. Results of such testing could be utilized to determine relationships between coefficients of road friction and percentage reductions in acceleration and/or velocity reductions of vehicle 102.

Predicted motion model 210 can include various parameters, in addition to a coefficient of road friction, that may describe the physical environment of vehicle 102. Such parameters can include wind speed, an upward or downward slope (e.g., positive or negative gradient), etc., of roadway 155. In an example in which vehicle 102 is an electric vehicle (i.e., vehicle 102 propulsion includes an electric motor in addition to or instead of an internal combustion engine), predicted motion model 210 can include battery and motor parameters, such as current sourcing (e.g., current drain capability), torque output capability from electric motor(s), etc. Predicted motion model 210 can then output a second time interval, which predicts a second time interval (T₀→T₂), indicating a time for vehicle 102 to pass second vehicle 103 and return to the designated lane of roadway 155. The second time interval (T₀→T₂) could include a distance margin for vehicle 102 to return to the designated lane of roadway 155, e.g., at a distance of 15 meters, 20 meters, 25 meters, etc., in a forward direction from second vehicle 103. The distance margin could be dependent upon ambient light conditions, road friction, prevailing weather conditions, ambient lighting conditions, etc.

In the example of FIG. 2, in response to predicted motion model 210 determining that the second time interval (T₀→T₂) is less than or equal to the first time interval (T₀→T₁), programming of computer 110 can actuate indicator 235 of human-machine interface 127 to indicate to an operator of vehicle 102 that the vehicle may pass or overtake second vehicle 103. In an example in which vehicle 102 is operating in an autonomous or semi-autonomous mode, programming of computer 110 can actuate propulsion and steering components of vehicle 102 in an operation to overtake or pass second vehicle 103. In response to predicted motion model 210 determining that the second time interval (T₀→T₂) is greater than the first time interval (T₀→T₁), programming of computer 110 can refrain from actuating indicator 235.

In an example, while vehicle 102 is engaged in an operation to pass or overtake second vehicle 103, computer 110 of vehicle 102 can update estimates of road friction utilizing inputs from various sensors 115. For example, computer 110 can utilize estimates of wheel slip coupled with an applied torque to estimate road friction while vehicle 102 is moving along roadway 155. Alternatively, or in addition, responsive to programming of computer 110 determining, utilizing outputs of a camera of sensors 115, that the surface of roadway 155 includes dry pavement, the computer may estimate a coefficient of road friction to be at least 0.7. In another example, responsive to programming of computer 110 determining, utilizing camera outputs, a presence of precipitation on the surface of roadway 155, programming of computer 110 may estimate road friction to be 0.6 or less. In response to an updated estimate of road friction indicating a decrease in road friction, predicted motion model 210 may compute an estimate of the time interval to pass or overtake second vehicle 103 utilizing a reduced acceleration capability and/or velocity capability. Predicted motion model 210 may additionally update a computation of the remaining portion of the first time interval (T₀→T₁), i.e., the available for passing second vehicle 103. In an example, responsive to predicted motion model 210 computing an updated motion prediction for vehicle 102, utilizing the reduced acceleration capability and/or velocity capability, model 210 can determine whether the remaining portion of the second time interval (T₀→T₂), i.e., the time to complete the passing of the second vehicle 103, has fallen below the remaining portion of the time available to pass vehicle 103 (T₀→T₁). Responsive to the remaining portion of the second time interval being greater than the remaining portion of the first time interval, programming of computer 110 may extinguish or deactivate indicator 235. In an example in which vehicle 102 is operating in an autonomous or semi-autonomous mode, programming of computer 110 may actuate steering and/or propulsion components to timely return vehicle 102 to the designated lane of roadway 155, such as at a location to the rear of second vehicle 103.

In an example, when vehicle 102 is operating in an autonomous or semi-autonomous mode, an operator of vehicle 102 may select to undertake a passing operation in a manner that limits acceleration and velocity of the vehicle. In such an example, an operator may select a control, such as via human-machine interface 127, which controls propulsion 129 to gently accelerate vehicle 102 and/or to obtain a velocity that is below an operator-specified limit. In another example, while operating in an assist mode, programming of 110 could control propulsion 129 to accelerate vehicle 102 and/or to obtain a velocity that is below an operator-specified limit. Programming of computer 110 could utilize other parameters in control propulsion 129, such as road friction, wind velocity, a computed grade of roadway 155, etc., in controlling propulsion 129, An operator-specified upper limit to velocity and/or acceleration may be utilized by predicted motion model 210 to extend the computed second time interval, which indicates the time to overtake or pass second vehicle 103.

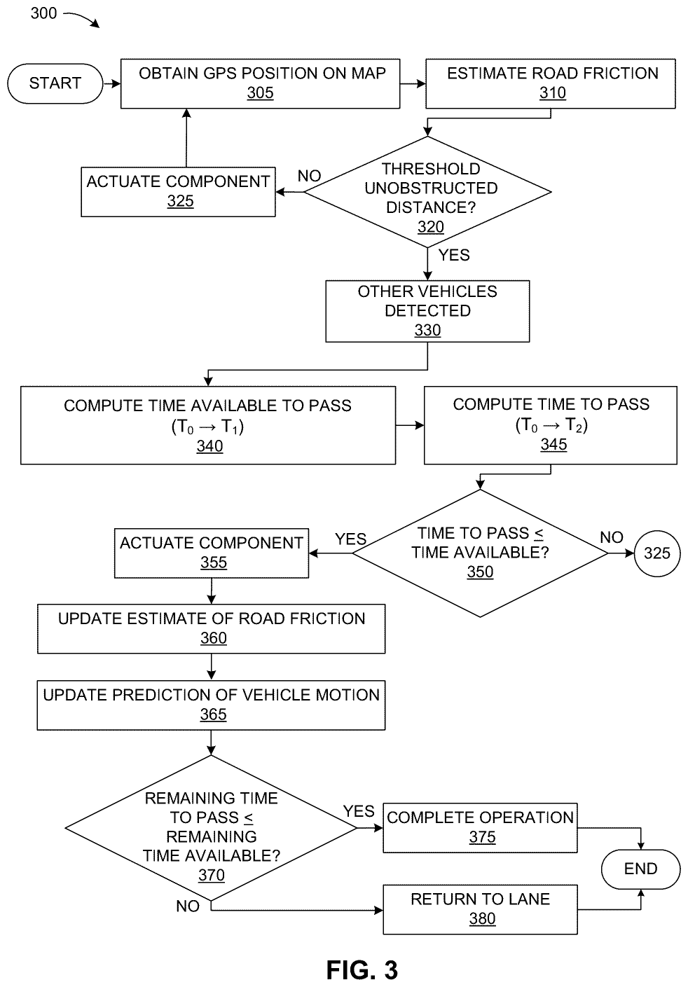

FIG. 3 is a flowchart of an exemplary process for actuating one or more vehicle 102 components for a vehicle passing operation. Blocks of process 300 could be executed by via programming of computer 110. Blocks of process 300 may be executed in the order presented or may be executed in a different order.

As a non-limiting overview of the process 300, in an example, vehicle 102 may be following second vehicle 103. An operation to overtake or pass second vehicle 103 may begin with computer 110 obtaining the GPS position of the vehicle for display on a digital map for viewing by the operator of vehicle 102. Programming of computer 110 may then estimate, utilizing data from sensors 115, road friction to determine if the conditions of a roadway 155 are favorable to passing second vehicle 103. Programming of computer 110 may additionally utilize sensor data from sensors 115, or sensor data from a nearby vehicle, e.g., second vehicle 103, to determine whether static or dynamic objects are located in the vehicles' path 150. In response to detecting the presence of a moving vehicle in an oncoming lane, such as vehicle 104, predicted motion model 210 of vehicle 102 can determine a first time interval until vehicle 104 is predicted to approach the immediate vicinity of vehicle 102. Predicted motion model 210 of vehicle 102 can determine a second time interval to overtake or pass second vehicle 103. Responsive to the second time interval being less than, or equal to, the first time interval, computer 110 of vehicle 102 can actuate a component of the vehicle to initiate passing of second vehicle 103. In an operation to overtake or pass second vehicle 103, programming of computer 110 can update an estimate of the coefficient of road friction, which may result in computer 110 actuating a component, such as an indicator, a propulsion component, steering component, etc., to return vehicle 102 to a designated lane of roadway 155, e.g., behind second vehicle 103, or to proceed with the operation to overtake or pass the second vehicle.

Process 300 begins at block 305, in which vehicle computer 110 obtains a position of vehicle 102 in a global-reference frame, e.g., including the location of vehicle 102 on a digital map 230 such as may be provided or displayed to the operator of vehicle 102. The operator of the vehicle 102, a human operator or a computer 110, may determine that road geography may indicate conditions that are favorable for passing second vehicle 103. Favorable conditions may include a length of roadway 155 that appears to be substantially free of curves, inclining slopes (e.g., positive gradients or gradients above a threshold), intersections, bridges, grades, areas of merging traffic, road construction, or other features of roadway 155 that could impede the passing of second vehicle 103 by vehicle 102.

Process 300 may continue at block 310, which may include estimating a coefficient of friction of the surface of roadway 155. Estimates of the coefficient of road friction can be obtained via sensors 115, such as wheel-slip data obtained during previous cornering maneuvers (e.g., near-limit cornering) of vehicle 102, data from a traction control subsystem of vehicle 102, estimates of surface roughness of roadway 155, and so forth. Estimates of road friction obtained at block 310 may additionally be computed based on input signals from a camera of vehicle 102, which may determine presence of precipitation on the surface of roadway 155 (e.g., water, snow, ice, etc.), which may decrease estimated road friction.

Process 300 may continue at block 320, at which computer 110 may determine that roadway 155 does not include a threshold of unobstructed distance for vehicle 102, which may be favorable for engaging in an operation to overtake or pass second vehicle 103. In an example, programming of computer 110 may determine that digital map 230 includes curves (e.g., by determining that road curvature over a distance ahead of the vehicle 102 is above an empirically determined threshold that may be specified for a current type of the vehicle 102), intersections, or other features that could impede passing of second vehicle 103 by vehicle 102. In an example, computer 110 may utilize an estimate of the coefficient of road friction, from block 310, to lengthen or reduce a threshold unobstructed distance that is inversely proportional to the coefficient of road friction. For example, responsive to an estimate of road friction of greater than a first threshold, e.g., 0.65, 0.7, 0.75, etc., computer 110 may specify a lower threshold of 1 km for vehicle 102 to pass second vehicle 103. However, responsive to an estimate of a coefficient of road friction that is less than the first threshold, e.g., 0.5, 0.55, 0.6, etc., computer 110 may specify a greater threshold distance for passing or overtaking second vehicle 103 of a greater distance, such as 1.2 kilometers, 1.25 kilometers, etc.

Process 300 may continue at block 325, which may include computer 110 actuating one or more components, such as a component of human-machine interface 127, to indicate that conditions are unfavorable for vehicle 102 to pass second vehicle 103.

Process 300 may continue at block 330, at which, in response to a determination at block 320 that roadway 155 appears to include a threshold of unobstructed distance in a forward direction of vehicle 102, e.g., a distance of greater than 1 km, computer 110 may obtain sensor data from sensors 115 or from sensors of a second vehicle, such as second vehicle 103.

Process 300 may continue at block 340, at which computer 110 may determine whether other vehicles are detected, such as vehicle 104 traveling in a direction opposite to vehicle 102 along roadway 155. In response to detection of a vehicle traveling in an opposite direction along roadway 155, sensors 115 of vehicle 102, and/or sensors of second vehicle 103, may compute or estimate of the velocity of detected vehicles. Block 340 may include computer 110 of vehicle 102 implementing predicted motion model 210, which may operate to predict a first time interval that indicates the time available to pass second vehicle 103 (T₀→T₁) in view of the estimated speed of vehicle 104 and the vehicle's distance from vehicle 102.

Process 300 may continue at block 345, at which computer 110 may utilize predicted motion model 210 to model the weight of vehicle 102 (e.g., passengers, baggage, payload, etc.), and any nonmotorized vehicles (e.g., a trailer) being pulled or towed by vehicle 102. Block 345 may additionally include predicted motion model 210 utilizing the propulsion capabilities of vehicle 102 (e.g., engine torque output) to predict a second time interval (T₀→T₂), indicating the time by vehicle 102 to overtake or pass second vehicle 103. Computation of a second time interval can include an estimate of the coefficient of road friction of vehicle 102 operating on roadway 155 to determine whether road friction is greater than a threshold value. For example, in response to roadway 155 exhibiting an estimated coefficient of road friction corresponding to a first threshold, e.g., 0.65, 0.7, 0.75, etc., predicted motion model 210 may model the motion of vehicle 102 as accelerating at a high rate and up to a specified velocity (e.g., equal to a posted upper speed limit) during an operation to overtake or pass second vehicle 103. In such an instance, the time interval (T₀→T₂) for vehicle 102 to overtake or pass second vehicle 103 may correspond to a nominal value. In another example, in response to roadway 155 having an estimated coefficient of road friction that is less than the first threshold, e.g., 0.5, 0.55, 0.6, etc., predicted motion model 210 may model the motion of vehicle 102 as accelerating at a lower rate and may limit the velocity of vehicle 102 to a value less than a posted speed limit (e.g., 5% less, 10% less, etc.). In such an instance, the time interval (T₀→T₂) for vehicle 102 to overtake or pass second vehicle 103 may correspond to a value greater than the nominal value.

Process 300 may continue at block 350, at which computer 110 may determine whether the time interval to pass second vehicle 103 is less than the available time interval. In such an instance, process 300 may continue at block 355. Responsive to the time interval to pass second vehicle 103 (T₀→T₂) being greater than the available time interval (T₀→T₁), process 300 may return to block 325, which may include actuating an indicator to inform the operator of vehicle 102 that prevailing conditions are unfavorable to pass second vehicle 103.

Process 300 may continue at block 355, which may include computer 110 actuating one or more components of vehicle 102, such as an indicator of human-machine interface 127, that vehicle 102 may engage in an operation to pass a second vehicle. In an example in which vehicle 102 is operating in an autonomous or semi-autonomous driving mode, computer 110 may actuate propulsion and steering of vehicle 102 to initiate passing of second vehicle 103.

Process 300 may continue at block 360, which may be performed while vehicle 102 is engaged in an operation to overtake or pass second vehicle 103. At block 360, computer 110 may obtain updated estimates of the coefficient of road friction utilizing data from one or more of sensors 115. Alternatively, or in addition, updated estimates of the coefficient of road friction may be available from the vehicle communications network, such as a controller area network (CAN) bus.

Process 300 may continue at block 365, at which, while vehicle 102 is engaged in an operation to overtake or pass second vehicle 103, computer 110 may update predicted motion model 210. In an example, in response to an updated estimate of the coefficient of road friction that indicates a decrease in road friction, such as after a transition from dry pavement to wet pavement, predicted motion model 210 may model the motion of vehicle 102 using a reduced velocity and acceleration. In another example, in response to an updated estimate of road friction indicating an increase in road friction, such as after a transition from wet pavement to dry pavement, predicted motion model 210 may model the motion of vehicle 102 using an increased velocity and acceleration.

Process 300 may continue at block 370, which may, based on results of predicted motion model 210 described in reference to block 365, include determining the remaining time of the first time interval (i.e., time available to complete the passing operation) is less than or equal to the remaining time of the second time interval (i.e., time for vehicle 102 to complete the passing operation).

If the decision of block 370 indicates that the remaining time to pass the second vehicle (T₀→T₂) is less than or equal to the remaining available time (T₀→T₁), process 300 may continue at block 375, which may include completing the passing operation.

If the decision of block 370 indicates that the remaining time to pass the second vehicle (T₀→T₂) is greater than the remaining available time (T₀→T₁), process 300 may continue at block 380, which may include actuating an indicator of a human-machine interface informing the operator of vehicle 102 that the vehicle should be returned to the designated lane of roadway 155, such as behind second vehicle 103.

After the completion of blocks 375 or 380, process 300 ends.

Operations, systems, and methods described herein should always be implemented and/or performed in accordance with an applicable owner's/user's manual and/or safety guidelines and/or in accordance with applicable laws and/or regulations.

In general, the computing systems and/or devices described may employ any of a number of computer operating systems, including, but by no means limited to, versions and/or varieties of the Ford Sync® application. AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It should further be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. The adjectives “first” and “second” are used throughout this document as identifiers and are not intended to signify importance, order, or quantity. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising a computer including a processor and memory, the memory storing instructions executable by the processor to:
determine, at a first vehicle, a first time interval that is available to pass a second vehicle operating in a path of the first vehicle;
compute, based on a predicted motion model that includes a first estimate of road friction of the first vehicle operating along the path, a second time interval for the first vehicle to pass the second vehicle; and
upon determining that the second time interval is less than or equal to the first time interval, actuate a component of the first vehicle.

2. The system of claim 1, wherein the actuated component is a component of a human-machine interface.

3. The system of claim 1, wherein the actuated component is a propulsion component.

4. The system of claim 1, wherein the predicted motion model includes an acceleration capability of the first vehicle that is reduced by the first estimate of road friction of the first vehicle.

5. The system of claim 1, wherein the instructions to update the second time interval includes instructions to:
compute a second estimate of the road friction; and
decrease a propulsion input to the predicted motion model responsive to the second estimate of the road friction.

6. The system of claim 1, wherein the instructions further include instructions to:
compute a second estimate of the road friction;
input the second estimate to the predicted motion model;
compute, via the predicted motion model, an update to the second time interval utilizing the second estimate of the road friction; and
actuate a component of a human-machine interface to return the first vehicle to the path responsive to the updated second time interval being greater than a remaining portion of the first time interval.

7. The system of claim 1, wherein the instructions further include instructions to:
compute a second estimate of the road friction;
input the second estimate to the predicted motion model;
compute, via the predicted motion model, an update to the second time interval utilizing the second estimate of the road friction; and
actuate a propulsion component of the first vehicle to the path responsive to the updated second time interval being less than a remaining portion of the first time interval.

8. The system of claim 1, wherein the instructions to compute the second time interval include instructions to:
input, to the predicted motion model, an upper limit to velocity or acceleration of the first vehicle responsive to receipt of an input to a human-machine interface component of the first vehicle.

9. The system of claim 1, wherein the predicted motion model includes an estimate of a weight of the first vehicle and an acceleration capability of the first vehicle.

10. The system of claim 1, wherein the instructions further include instructions to:
detect a third vehicle having a direction of travel substantially opposite to a direction of travel of the first vehicle, and wherein the second time interval is based on the direction of travel of the second vehicle, and wherein the instructions to detect the third vehicle include instructions to communicate with the second vehicle via a vehicle-to-vehicle (V2V) communications link.

11. The system of claim 1, wherein the instructions further include instructions to obtain an indication of a location of the first vehicle on a road prior to executing the instructions to determine the second time interval.

12. A method, comprising:
determining, at a first vehicle, a first time interval to pass a second vehicle operating in a path of the first vehicle;
computing based on a predicted motion model that includes a first estimate of road friction of the first vehicle operating along the path, a second time interval for the first vehicle to pass the second vehicle; and
upon determining that the second time interval is less than or equal to the first time interval, actuating a component of the first vehicle.

13. The method of claim 12, wherein the actuated component is a component of a human-machine interface.

14. The method of claim 12, wherein the actuated component is a propulsion component.

15. The method of claim 12, wherein the predicted motion model includes an acceleration capability of the first vehicle that is reduced by the first estimate of road friction of the first vehicle.

16. The method of claim 12, further comprising:
computing a second estimate of the road friction; and
decreasing a propulsion input to the predicted motion model responsive to the computed second estimate of the road friction.

17. The method of claim 12, further comprising:
computing a second estimate of the road friction;
inputting the second estimate to the predicted motion model;
computing, via the predicted motion model, an update to the second time interval utilizing the second estimate of the road friction; and
actuating a component of a human-machine interface to return the first vehicle to the path responsive to the updated second time interval being greater than a remaining portion of the first time interval.

18. The method of claim 12, further comprising:
computing a second estimate of the road friction;
inputting the second estimate to the predicted motion model;
computing, via the predicted motion model, an update to the second time interval utilizing the second estimate of the road friction; and
actuating a propulsion component of the first vehicle to the path responsive to the updated second time interval being less than a remaining portion of the first time interval.

19. The method of claim 12, further comprising:
receiving an upper limit to velocity or acceleration of the first vehicle responsive to receipt of an input signal from a human-machine interface component of the vehicle; and
inputting, to the predicted motion model, an upper limit to velocity or acceleration of the first vehicle.

20. The method of claim 12, further comprising:
obtaining electronic horizon data indicating a position of the first vehicle on a road depicted on a digital map prior to computing the second time interval.
